(19) United States
(12) Patent Application Publication
(10) Pub. No.: US 2023/0391597 A1
(43) Pub. Date: Dec. 7, 2023

(54) Lightweight Pole Stabilized Scissor Lift

(71) Applicant: Brandon Nguyen, Fort Lupton, CO (US)

(72) Inventor: Brandon Nguyen, Fort Lupton, CO (US)

(21) Appl. No.: 17/834,116

(22) Filed: Jun. 7, 2022

(51) Int. Cl. B66F 11/04

(52) U.S. Cl. CPC B66F 11/042

(57) ABSTRACT

A lightweight portable scissor lift capable of transport in a typical light duty pick-up truck is described. The lift includes a base having an attachment mechanism to secure it to pole or other fixed structure thereby stabilizing the base and permitting a bucket to be extended upwardly without risk of the lift tipping.

### BACKGROUND

A scissor lift is a piece of commercial equipment that comprises a compartment (or bucket) designed to carry a human that is mounted on the distal end of an extensible scissor-style boom that extends vertically upwardly. The boom in turn is attached to a weighted base that acts to stabilize the bucket while the bucket is vertically extended with one or more persons in the bucket. The base can include motorized wheels that permits it to be shuttled to a desired location.

Even small portable scissor lifts tend to be very heavy. A one man scissor lift 10 as shown in FIG. 1 that can extend the bucket 45 a moderate 8-14 feet high typically weights about 1000 lbs. Much of this weight is contained in a base 15 that includes a center compartment 20 containing a substantial amount of ballast 20. Because these units are so heavy they are usually supported by wheels 25 & 30, two of which are driven by an electric motor to facilitate moving the lift around. Batteries are provided to propel the drive wheels but also power an hydraulic pump that is operatively coupled with hydraulic actuators 40. The hydraulic actuators in turn raise and lower the scissor mechanism 35 and the associated bucket.

While these portable scissor lifts are more than small enough to be received in a standard ½ ton pickup bed, they strain the capacity of the truck especially when other equipment and gear must be transported as well. Even when the load weight is not an issue, getting the lift in and out of the truck bed can be difficult. At least three and preferably four men are required to move a typical lift from a pickup bed and even then it is a very heavy and potentially dangerous lift.

Given the weight, a heavier duty truck is typically required to transport a prior art scissor lift, and a motorized lift deck is also required since the scissor lift cannot be safely lifted by a typical two-man work crew. Because of this, a work crew requiring the one man portable scissor lift, such as a municipal crew tasked with maintaining utility poles, has to not only reserve the lift for use but also reserve a suitable truck to transport it. As one can imagine, a maintenance facility may only have a limited number of heavy duty trucks with lift decks, and as such, a suitable truck may not be available when a crew needs it to transport the scissor lift. This can slow down maintenance or repair of a condition that requires a lift to reach it.

### BRIEF DESCRIPTION OF THE DRAWINGS

FIG. 1 is a depiction of a typical prior art portable one man 8-14 ft scissor lift.

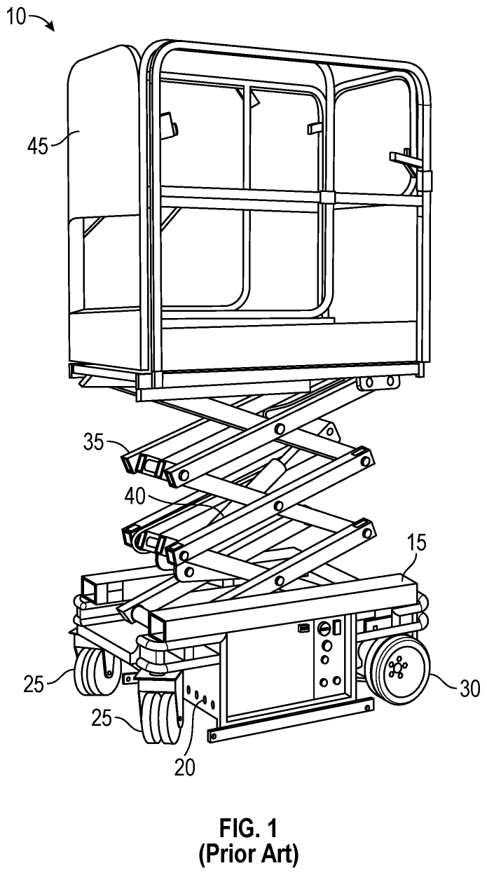

FIG. 2 is a perspective front view of a lightweight pole stabilized scissor lift according to an embodiment of the present invention.

FIG. 3 is a perspective rear view of the lightweight pole stabilized scissor lift according to an embodiment of the present invention.

FIG. 4 is a side view of the lightweight pole stabilized scissor lift coupled to a utility pole according to an embodiment of the present invention.

FIG. 5 is a close up perspective view of the stabilization system of the lightweight pole stabilized scissor lift according to an embodiment of the present invention.

### DETAILED DESCRIPTION

Embodiments of the invention comprise a portable scissor lift that is lightweight in comparison to prior art scissor lifts permitting the lift to be transported in a typical pickup truck of the type commonly owned by both municipalities, businesses, and individual workers. Accordingly, the transport and associated use of the lift is not tied to the availability of a heavy duty truck. At least some embodiments of a one man scissor lift capable of extending a user 8-14 feet high weigh less than 200 pounds, preferably less than 150 pounds, and most preferably less than 100 lbs not only permitting use in a ½ ton pick-up truck, but also permitting a typical two men crew to easily lift it in and out of the truck.

The weight of a prior art scissor lift includes a significant amount of ballast contained in the base thereof. This ballast is eliminated in embodiments described herein. Further weight savings result in some embodiments through the elimination of an electric propulsion motor as the unit can be easily wheeled around, and the reduction in the size of the battery pack as it will only be needed to provide power to the lift motor. To further reduce weight, the structural elements of the base can be made lighter as they no longer have to be designed and constructed to contain and support the ballast weight. In some embodiments, the base and other components can be made of aluminum alloys, and materials other than steel.

As can be appreciated, without a weighted base the effective center of gravity of the lift will be shifted upwardly as the boom and a bucket laden with a worker and associated equipment is extended upwardly. To prevent the lightweight scissor lift from becoming unstable and toppling over, a stabilization system is provided that braces against a utility pole or other post that is firmly and immovably secured in and/or to a ground surface.

In at least one embodiment, the stabilization system essentially comprises: (1) one or more straps that are attached or attachable to the base and are configured to wrap around and be tightened against a structure, such as a pole; and (2) one or more rigid tensioning braces that are configured to firmly butt against the structure. When the stabilization system is used, the scissor lift is inhibited from tipping when the laden bucket is extended upwardly.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

An Embodiment of a Lightweight Portable Scissor Lift

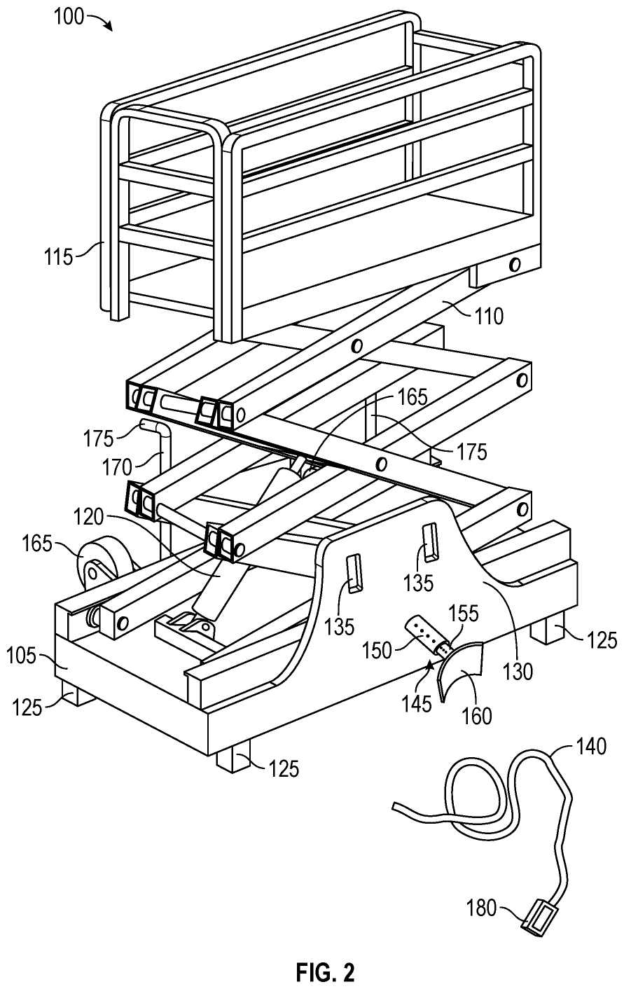

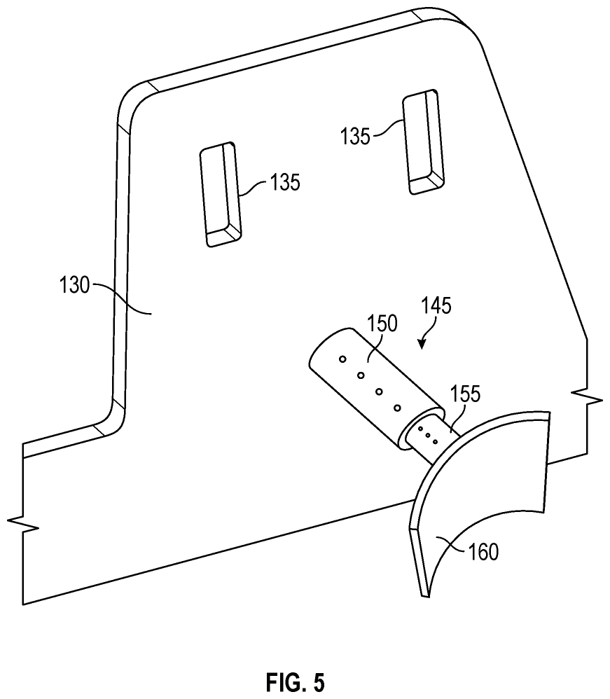

FIGS. 2-5 are illustrations of an embodiment of a lightweight portable scissor lift. It comprises a base 105 with a stabilization system associated therewith, a bucket 115 configured to hold one or more persons, and a scissor mechanism 110 secured to the base and the bucket respectively and operationally configured to move the bucket upwardly and downwardly relative to the base.

The bucket 115 is of any suitable design and typically includes a bucket base or floor with railings extending upwardly from the edges or sides of the floor. The bucket can be constructed from any suitable materials but typically is comprised of one or both of steel and aluminum. The width and length of the bucket can vary depending on the capacity of the bucket and the associated scissor lift. Lightweight portable scissor lifts of the type described herein are most often one man lifts and have a bucket sized to hold one man and his necessary equipment; however, embodiments are contemplated with larger buckets designed to hold two persons.

The scissor mechanism 110 typically comprises a plurality of elongated plates or rods that are pivotally attached at their ends to other plates or rods, mounting points on the base, and/or mounting points on the bottom side of the bucket base or floor. Further, the centers of each elongated plate are attached to a corresponding plate. The resulting connected structure of pivotally connected elongated plates can be vertically expanded or retracted in an accordion-type fashion. The scissor mechanism further includes one or more linear actuators that are coupled to the structure of elongated plates. When the actuators are extended the structure of elongated plates expands upwardly raising the bucket. Conversely, when retracted, the actuator compacts the structure of elongated plates downwardly thereby lowering the bucket. The linear actuators can be of any suitable type including hydraulic actuators and screw type actuators that typically include an electric motor contained therein. Scissor mechanism using hydraulic actuators also typically include an electrically powered hydraulic pump to provide pressurized fluid to the actuators.

The base 105 comprises a platform on to which the scissor mechanism 110 is mounted. The base also houses and contains any pumps or motors and batteries used to power the scissor mechanism. The embodiment illustrated includes four feet (or foot pads) 125 that support the base and the entire lift on an underlying ground surface. As can be appreciated that feet may be length adjustable to allow the lift to be leveled for use on uneven ground. The base can be made of any suitable materials but is typically comprised of one or both of steel or aluminum.

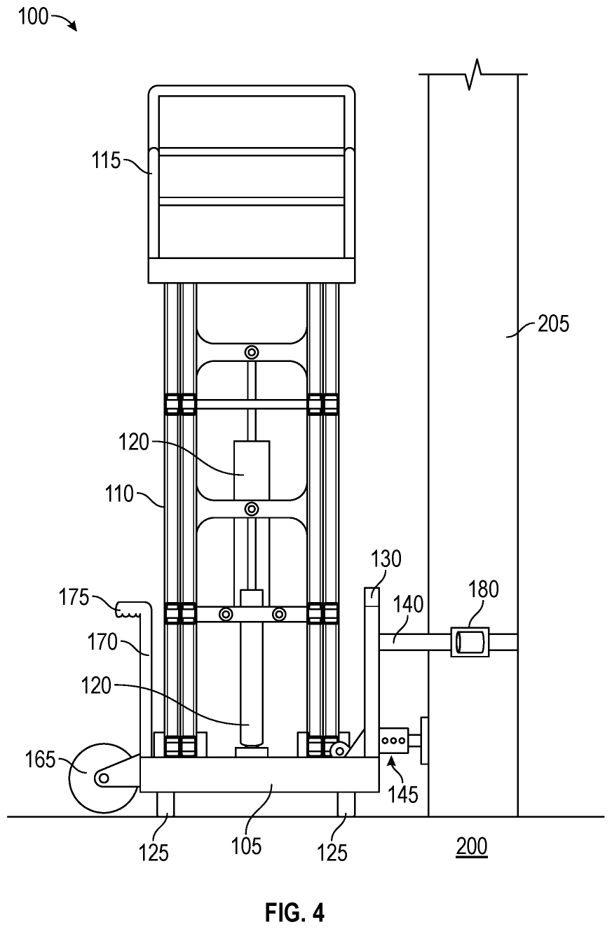

As best shown in FIG. 2, the front side of the base 105 includes a stabilization system that allows the base to be secured to a pole 205 (See FIG. 4) or other fixed structure. The stabilization system includes a brace assembly 145, an upwardly extending plate 130 having strap slots 135 extending therethrough, and a strap 140 with a ratchet buckle 180 for receipt through the slots.

The brace assembly 145 includes a tubular brace sleeve 150 that extends generally orthogonally outwardly from the upwardly extending plate 130 approximate the plate's base. A brace extender sleeve or rod 155 is configured for slidable receipt in the brace sleeve such that it can be adjusted outwardly and inwardly to brace the end plate 160, which is typically flat or curved, against a fixed structure. The brace sleeve and the brace extender sleeve can have a series of bores drilled through them wherein a pin or bolt can be placed to secure the brace extender sleeve in a desired position. Brace assemblies of other configurations are contemplated as well as would be obvious to one of ordinary skill in the art given the benefit of this disclosure.

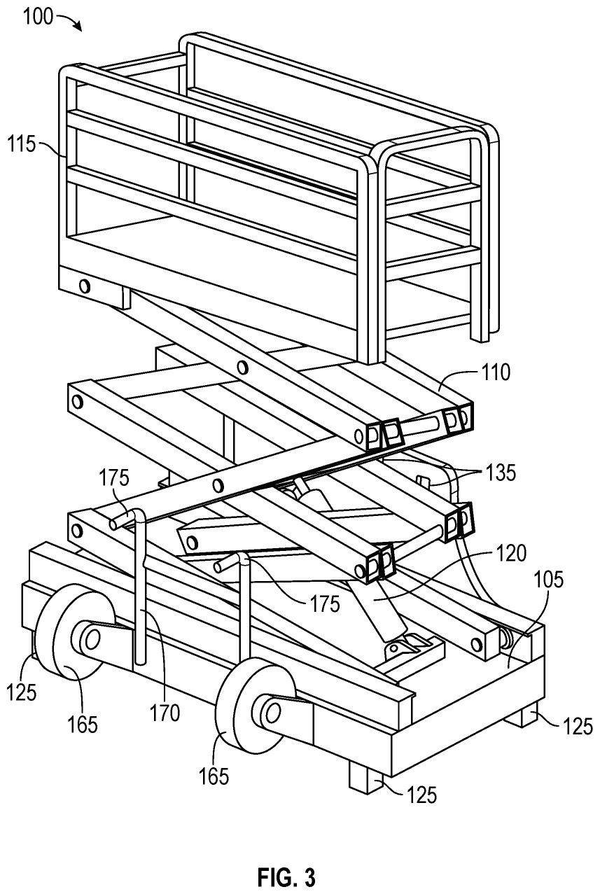

As best shown in FIG. 3 a set of wheels 165 are provided on the backside of the base. Further a pair posts 170 extends vertically from the base and terminate at respective hand grips 175. The wheels are normally suspended just above the ground when the lift is resting on a ground surface by way of its legs.

However, when the lift is compacted with the scissor mechanism fully retracted, a user grabbing the hand grips can tilt the lift rearwardly onto the wheels so that it can be move around in a manner similar to a dolly or hand cart. As can be appreciated, a similar means of moving a lift would not be possible with typical prior art lifts because of their weight.

A Method of using a Lightweight Scissor Lift

To transport the lift 100 to a work site it is typically lifted by two or more persons into and onto a cargo area of a suitable vehicle. Typically, the lift is lifted into the bed of a standard pickup truck where it is secured typically with tie down straps. The vehicle containing the lift is then driven to a work site. In many municipal and commercial settings, the lift will be associated with a work crew of two or possibly three people that simultaneously ride in or drive the vehicle to the work site.

Upon arriving at a work site, the lift is unstrapped and lowered off of or out of the cargo area by the two or three workers and deposited on an adjacent ground surface 200. To move the lift to the location where it is to be used, a user tilts is rearwardly by pulling on the hand grips 175 while bracing the base with one of his or her feet until its wheels 165 make contact with the ground and the lift's feet 125 are raised off of the ground. The tilted lift is then wheeled to a location proximate a pole 205 or other fixed structure to which the lift is to be secured.

At the desired location of lift deployment, the front side of the lift containing the stabilization system is positioned in front of the pole 205 so that the brace assembly 145 generally and the brace end plate 160 specifically is butted against the pole. As necessary the position of brace assembly can be adjusted, such as by extending or retracting an brace extender sleeve 155 in a tubular sleeve 150 and locking it in position.

Once the lift is in position, the rachet strap 140 can be fed around the pole and through the slots 135 in the base plate 130. The end of the strap is fed through the rachet buckle 180 and tightened around the pole pulling the brace end plate in firmer contact with the post as well. In this configuration, the lift is effectively fixed to the pole and can then be used to elevate a worker in the bucket 115.

A worker is then elevated in the bucket by extending the scissor mechanism using the linear actuators, which are typically powered by one or more electric motors. The worker performs whatever repair or maintenance task he/she needs to from the extended bucket, and then the bucket is lowered until fully retracted.

The strap is loosened and removed from around the pole and the lift is wheeled back to the truck and lifted thereon. The lift is secured in the truck bed and transported back to its storage location.

Variations and Alternative Embodiments

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A lightweight vertically-extensible lift for lofting one or more persons and associated equipment, the vertically-extensible lift comprising:
a bucket;
a boom; and
a base with a stabilizing system, the stabilizing system including,
a first rigid brace extending outwardly from the base, and configured to butt against a generally vertical surface, and
a first strap being attached to the base and being configured to encircle the structure associated with the generally vertical surface.

2. The vertically-extensible lift of claim 1, wherein the boom comprises a scissor mechanism.

3. The vertically-extensible lift of claim 1, wherein the bucket is configured to hold one or more people.

4. The vertically-extensible lift of claim 1, further including wheels rotatably secured to a back side of the base.

5. The vertically-extensible lift of claim 1, wherein a weight of the lift is less than 200 pounds.

6. The vertically-extensible lift of claim 1, wherein a weight of the lift is less than 100 pounds.

7. The vertically-extensible lift of claim 1, wherein the bucket can be extended to a vertical height of 8-14 feet.

8. The vertically-extensible lift of claim 1 further comprising a first strap tightening mechanism associated with the first strap.

9. The vertically-extensible lift of claim 8, wherein the first strap tightening mechanism comprises a ratchet strap tensioner.

10. The vertically-extensible lift of claim 1, wherein the first strap is a woven Nylon strap.

11. The vertically-extensible lift of claim 1, further including a second strap being attached to the base and being configured to encircle the structure associated with the generally vertical surface.

12. The vertically-extensible lift of claim 1, further including a second rigid brace extending outwardly from the base, and configured to butt against the generally vertical surface.

13. The vertically-extensible lift of claim 1, wherein a length of the first rigid brace is adjustable.

14. The vertically-extensible lift of claim 1, wherein the base further includes a plurality of foot pads.

15. The vertically-extensible lift of claim 14, further including wheels rotatably secured to a backside of the base, the wheels not being in contact with a ground surface when the base is resting on the ground surface by way of the plurality of foot pads.

16. The vertically-extensible lift of claim 15, further including a pair of hand grips, the pair of handgrips being located on the ends of a pair of generally vertically-extending posts mounted to the backside of the base.

17. The vertically-extensible lift of claim 1, wherein the base does not include ballast weights.

18. A lightweight vertically-extensible lift for lofting one or more persons and associated equipment, the vertically-extensible lift comprising:
a bucket configured to hold one or more people;
a scissor boom; and
a base having a front side, a back side and a bottom side,
the front side including a stabilizing system, the stabilizing system having a rigid pole brace extending outwardly from the base that is configured to butt against a pole, and a strap being attached to the base and being configured to encircle the pole, the strap including a buckle,
the bottom side including a plurality of foot pads, and
the back side having (i) two or more wheels rotatably mounted thereto wherein the wheels do not make contact with an underlying ground surface when the base is resting on the underlying ground surface by way of the plurality of foot pads, and (ii) a pair of generally vertically-extending posts each terminating in a hand grip.

19. The vertically-extensible lift of claim 18, wherein the base does not include ballast weights.

20. The vertically-extensible lift of claim 18, wherein a length of the rigid pole brace is adjustable.
